(19) United States
(12) Patent Application Publication
(10) Pub. No.: US 2024/0294209 A1
(43) Pub. Date: Sep. 5, 2024

(54) VEHICLE CONTROL APPARATUS AND A NON-TRANSITORY COMPUTER-READABLE STORAGE MEDIUM

(71) Applicant: TOYOTA JIDOSHA KABUSHIKI KAISHA, Toyota-shi (JP)

(72) Inventor: Kazuya OKAMOTO, Toyota-shi (JP)

(73) Assignee: TOYOTA JIDOSHA KABUSHIKI KAISHA, Toyota-shi (JP)

(21) Appl. No.: 18/593,307

(22) Filed: Mar. 1, 2024

(30) Foreign Application Priority Data
Mar. 3, 2023 (JP) 2023-032425

(51) Int. Cl. B62D 15/02; G08G 1/16

(52) U.S. Cl. CPC B62D 15/0265; G08G 1/166

(57) ABSTRACT

A vehicle control apparatus is capable of executing a first control for reducing a collision possibility between a vehicle and a target when the collision possibility satisfies a predetermined collision condition, and a second control for controlling a steered angle of the vehicle so as to suppress the vehicle from deviating from a traveling area defined by a boundary. The vehicle control apparatus determines whether or not a collision target that satisfies the collision condition satisfies a predetermined prohibition condition. The vehicle control apparatus prohibits an execution of the second control when the collision target satisfies the prohibition condition, and permits the execution of the second control when the collision target does not satisfy the prohibition condition.

### TECHNICAL FIELD

The present disclosure relates to a vehicle control apparatus capable of executing a first control for reducing a collision possibility between a vehicle and a target when the collision possibility satisfies a predetermined collision condition, and capable of executing a second control for controlling a steered angle of the vehicle so as to suppress the vehicle from deviating from a traveling area, and a non-transitory computer-readable storage medium storing a program for causing a processor to execute the first control and the second control.

### BACKGROUND

Conventionally, there has been known a vehicle control apparatus which is capable of executing “a deceleration control for decelerating a vehicle so as to reduce a collision possibility” as a first control and executing a deviation suppression control as the second control. For example, the vehicle control appratus described in Patent Document 1 (hereinafter, referred to as a “conventional apparatus”) executes the deceleration control (the first control) when a collision condition is satisfied, and executes the deviation suppression control (the second control) when a deviation condition is satisfied. The collision condition is satisfied when the vehicle is highly likely to collide with a target. The deviation condition is satisfied when the vehicle is highly likely to deviate from a traveling area or when the vehicle deviates from the traveling area.

When the collision condition is satisfied, the conventional apparatus determines whether or not a steered direction is the same as a collision avoidance direction that avoids the collision with the target that satisfies the collision condition (hereinafter, referred to as a “collision target”). The steered direction is specified by a steered angle which is being controlled by the deviation suppression control. The conventional apparatus executes the deceleration control by stopping execution of the deviation suppression control when the steered direction and the collision avoidance direction are different from each other, and simultaneously executes the deviation suppression control and the deceleration control when the steered direction and the collision avoidance direction are the same.

The reason why the execution of the deviation suppression control is stopped when the steered direction and the collision avoidance direction are different is to prevent the vehicle from traveling in a direction in which the vehicle collides with the collision target. Accordingly, it is possible to suppress an occurrence of a situation in which a collision avoidance effect decreases due to the deviation suppression control.
Patent Document 1: Japanese Patent Application Laid-Open No. 2021-94955

### SUMMARY

If the collision target is “a target that is located outside a boundary of the traveling area and that can move autonomously (e.g., a pedestrian, a two-wheeled vehicle, etc.)”, the collision target may move to an inside of the traveling area in an attempt to avoid the collision with the vehicle. In such a case, the conventional apparatus determines that the steered direction and the collision avoidance direction are the same, and the deviation suppression control and the deceleration control may be executed simultaneously. When the deviation suppression control is executed in such a case, the vehicle and the collision target move in the same direction (that is, the vehicle and the collision target move to the inside of the traveling area), so that the collision possibility increases.

On the other hand, when the deviation suppression control and the deceleration control are simultaneously executed for a target such as a guardrail that does not move, the collision possibility decreases.

The present disclosure has been made to address the above-described problem. That is, it is an object of the present disclosure to provide a vehicle control apparatus capable of reducing the collision possibility by appropriately selecting whether to execute the deceleration control (first control) and the deviation suppression control (second control) simultaneously or only the deceleration control (first control) according to the collision target.

The vehicle control apparatus (10) (hereinafter, referred to as a “present disclosure apparatus”) according to the present disclosure is capable of executing a first control for reducing a collision possibility between a vehicle and a target (step 325) when the collision possibility satisfies a predetermined collision condition (step 320 “Yes”), and a second control for controlling a steered angle of the vehicle so as to suppress the vehicle from deviating from a traveling area defined by a boundary (step 450).

The present disclosure apparatus configured to:
determine whether or not a collision target that satisfies the collision condition satisfies a predetermined prohibition condition (step 330);
prohibit an execution of the second control (step 335, step 435, step 445) when the collision target satisfies the prohibition condition (step 330 “Yes”); and
permit the execution of the second control (step 340, step 435, step 445) when the collision target does not satisfy the prohibition condition (step 330 “No”).

Whether the collision probability increases or decreases when the second control (a deviation suppression control) is executed is determined according to the collision target. According to the present disclosure apparatus, when the collision target satisfies the prohibition condition, the execution of the second control is prohibited and only the first control (a deceleration control) is executed, and when the collision target does not satisfy the prohibition condition, the simultaneous execution of the first control and the second control becomes possible. Accordingly, it is possible to appropriately select whether the first control and the second control are executed at the same time or only the first control is executed according to the collision target, and it is possible to reduce a possibility that the collision possibility increases due to the execution of the second control and to increase a possibility that the collision possibility decreases due to the execution of the second control.

### BRIEF DESCRIPTION OF THE DRAWINGS

FIG. 1 is a schematic system configuration diagram of a vehicle control apparatus according to an embodiment of the present disclosure.

FIG. 2 is a drawing for describing an outline of operation of the vehicle control apparatus.

FIG. 3 is a flowchart illustrating a deceleration control routine executed by a CPU of a vehicle control ECU shown in FIG. 1.

FIG. 4 is a flowchart illustrating a deviation suppression control routine executed by the CPU of the vehicle control ECU shown in FIG. 1.

### DETAILED DESCRIPTION

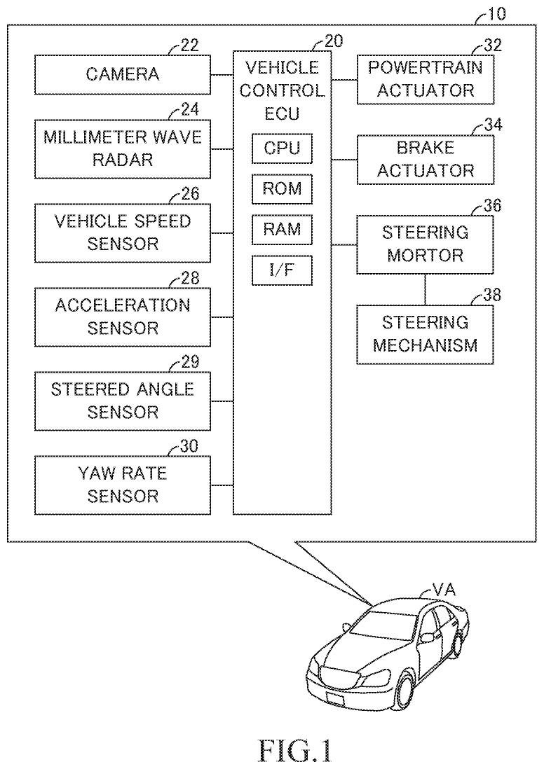

As illustrated in FIG. 1, a vehicle control apparatus 10 (hereinafter, referred to as “the device 10”) according to the present embodiment is applied to a vehicle VA and includes components illustrated in FIG. 1.

A vehicle control ECU20 is an ECU capable of executing a deceleration control and a deviation suppression control, and is hereinafter referred to as an “ECU20”.

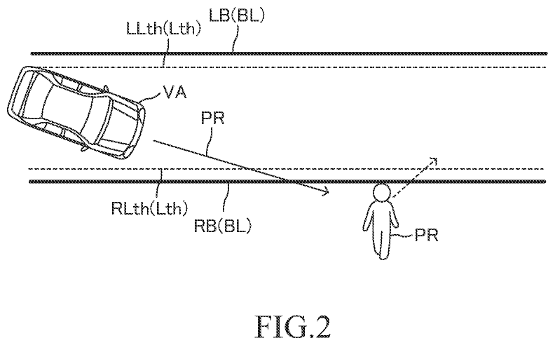

The deceleration control is a control for decelerating the vehicle VA regardless of a braking operation of a driver in order to reduce a collision possibility that is a possibility of a collision between the vehicle VA and a target, when the collision possibility satisfies a predetermined collision condition. The deviation suppression control is a control for controlling a steered angle θ of the vehicle VA so as to suppress the vehicle VA from deviating from a traveling area TA (see FIG. 2). Note that the deceleration control may be referred to as a “first control”, and the deviation suppression control may be referred to as a “second control”.

In the present specification, an “ECU” is an electronic control unit including a microcomputer as a main part. The ECU is also referred to as a controller and a computer. The microcomputer includes a CPU (a processor), a ROM, RAM, an interface, and the like. The CPU realizes various functions by executing instructions (routines) stored in a memory (ROM). At least one function realized by the ECU20 may be realized by a plurality of ECUs.

A camera 22 acquires image data by capturing a scene in front of the vehicle VA. The camera 22 acquires camera target data and boundary data based on the image data. The camera target data includes a position of the target located in front of the vehicle VA with respect to the vehicle VA. The boundary data includes a position of a boundary BL defining the traveling area TA with respect to the vehicle VA. For example, the boundary BL is a white line on a road, a guardrail, a curb, and a wall. The camera 22 transmits the image data, the camera target data, and the white boundary data to the ECU20.

The millimeter wave radar 24 transmits a millimeter wave to the front of the vehicle VA, and receives a reflected wave so as to acquire radar target data including “a position of the target with respect to the vehicle VA” and “a relative speed Vr of the target with respect to the vehicle VA”. The reflected wave is the transmitted wave that is reflected by the target. The millimeter-wave radar 24 transmits the radar target data to the ECU20.

A vehicle speed sensor 26 measures a vehicle speed Vs representing a speed of the vehicle VA. An acceleration sensor 28 measures an acceleration G in a front-rear axial direction of the vehicle VA. In the present embodiment, the acceleration G becomes a positive value when the vehicle VA accelerates, and becomes a negative value when the vehicle VA decelerates. A steered angle sensor 29 measures the steered angle θ of steered wheels of the vehicle VA. A yaw rate sensor 30 measures a yaw rate Yr of the vehicle VA. The ECU20 acquires measured values from these sensors 26-30.

A powertrain actuator 32 changes a driving force generated by a driving device (for example, an internal combustion engine and/or an electric motor) of the vehicle VA. A brake actuator 34 controls a braking force applied to wheels of the vehicle VA. The steering motor 36 is incorporated in the steering mechanism 38. The steering mechanism 38 is a mechanism for turning the steered wheels in response to an operation on a steering wheel. The steering motor 36 causes the steering mechanism 38 to generate an assist torque for assisting the operation on the steering wheel in response to an instruction from the ECU20. Furthermore, the steering motor 36 causes the steering mechanism 38 to generate an automated-steering torque for changing the steered angle θ of the steered wheels.

### (Deceleration Control)

The ECU20 acquires a TTC (Time To Collision) indicating a time required for the vehicle VA to collide with the target as a “collision index value indicating the collision possibility”. In particular, the ECU20 acquires the TTC by dividing the distance D between the vehicle VA and the target by the relative speed Vr. As the TTC becomes shorter, the collision possibility becomes higher.

The ECU20 determines that the collision condition is satisfied when the minimum TTC is equal to or shorter than a threshold time Tth, and executes the deceleration control for avoiding or suppressing the collision with the collision target that is a target having the minimum TTC. In the deceleration control, the ECU20 decelerates the vehicle VA by controlling the powertrain actuator 32 and the brake actuator 34 such that the acceleration G coincides with a target acceleration Gtgt set in advance to a predetermined negative value.

### (Deviation Suppression Control)

The ECU20 identifies a right boundary RBL (refer to FIG. 2) that defines a right end of the traveling area TA in which the vehicle VA travels, and a left boundary LBL (see FIG. 2) that defines a left end of the traveling area TL, based on the boundary data. When the right boundary RBL and the left boundary LBL do not need to be distinguished, each of these is referred to as a “boundary BL”.

The ECU20 sets start reference lines Lsth (a right start reference line RLsth and a left start reference line LLsth) at a position separated from each of boundaries BL by a predetermined distance in a direction perpendicular to each of the boundaries BL (see FIG. 2). In the embodiment illustrated in FIG. 2, the start reference line Lsth is set inside the boundary BL, but may be set outside the boundary BL. The ECU20 sets the end reference lines Leth (not shown) inside each of the start reference lines Lsth.

When one of the following conditions 1 and 2 is satisfied, the ECU20 determines that the deviation condition is satisfied, and executes the deviation suppression control.

Condition 1: A predicted route PR of the vehicle VA intersects the start reference line Lsth, and a distance D between the start reference line Lsth that the predicted route intersects and the vehicle VA is equal to or shorter than a threshold distance Dth.

Condition2: The Vehicle VA deviates from the start reference line Lsth.

The ECU20 specifies the predicted route PR from the present position of the vehicle VA to a predetermined distance destination based on the vehicle speed Vs and the yaw rate Yr.

In the deviation suppression control, the ECU20 controls the steering motor 36 such that the steered angle θ coincides with the target steered angle θtgt for suppression the vehicle VA from deviating from the traveling area TR.

The ECU20 ends the deviation suppression control when an end condition that the vehicle VA is positioned inside the end reference line Leth is satisfied.

### (Outline of Operation)

An outline of the operation of the ECU20 of the apparatus 10 will be described.

The ECU20 determines whether or not “the collision target satisfying the collision condition” satisfies a prohibition condition. The ECU20 prohibits an execution of the deviation suppression control when the collision target satisfies the prohibition condition, and permits the execution of the deviation suppression control when the collision target does not satisfy the prohibition condition.

The ECU20 determines that the collision target satisfies the prohibition condition when the collision target is located outside the border BL and the collision target is a movable particular target. For example, a pedestrian PD (see FIG. 2), a two-wheeled vehicle, and the like are set in advance as the movable particular target.

When the collision target is located outside the boundary BL and the collision target is the movable particular target, as shown in FIG. 2, there is a possibility that the collision target moves to the inside of the boundary BL in order to avoid the collision with the vehicle VA. In such case, when the deviation suppression control is executed, the vehicle VA and the collision target may move in the same direction. When the collision target is located outside the border BL and the collision target is the movable particular target, the ECU20 prohibits the execution of the deviation suppression control.

On the other hand, when the collision target is an immovable target (for example, a guardrail, a wall, or the like), the collision possibility is lower when the deviation suppression control is executed than when the deviation suppression control is not executed. When the collision target is the immovable target, the prohibition condition is not satisfied, and therefore, the ECU20 permits the deviation suppression control to be executed.

According to the present embodiment, it is possible to appropriately select whether the deviation suppression control and the deceleration control are executed at the same time or only the deceleration control is executed according to the collision target, and it is possible to reduce a possibility that the collision possibility increase by executing the deviation suppression control and to increase a possibility that the collision possibility decrease by executing the deviation suppression control.

### (Specific Operation)

### <Deceleration Control Routine>

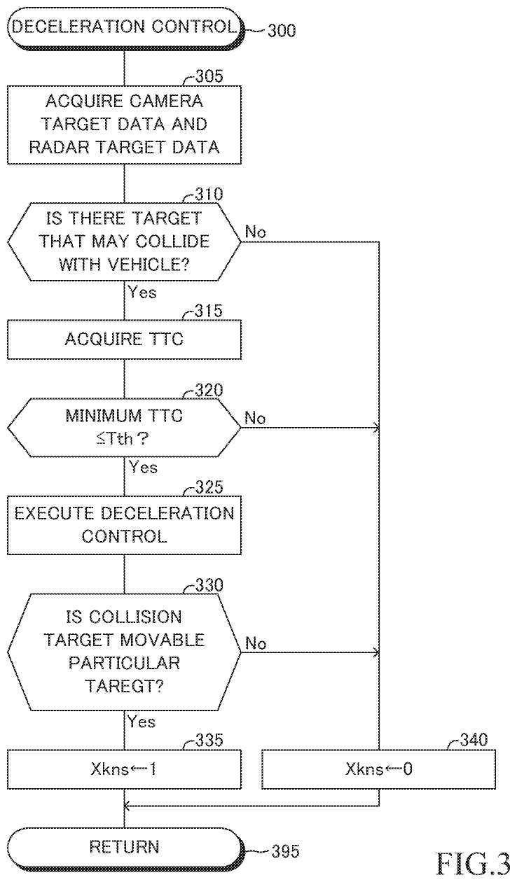

The CPU of the ECU20 executes a deceleration control routine illustrated by the flowchart in FIG. 3, every time a predetermined period elapses.

When an appropriate time point comes, the CPU starts a process from step 300 of FIG. 3 and executes step 305 and step 310.

Step 305: The CPU acquires the camera target data from the camera 22 and the radar target data from the millimeter-wave radar 24.

Step 310: The CPU determines whether or not there is a target that may collide with the vehicle VA based on the predicted course PR of the vehicle VA.

When there is the target that may collide with the vehicle VA, the CPU makes a “Yes” determination in step 310 and executes step 315 and step 320.

Step 315: The CPU acquires the TTC of the target that may collide with the vehicle VA.

Step 320: The CPU steps determines whether or not the minimum TTC is equal to or shorter than the threshold time Tth.

When the minimum TTC is equal to or shorter than the threshold time Tth, the CPU determines that the collision condition has been satisfied. The CPU makes a “Yes” determination in step 320 and executes steps 325 and 330.

Step 325: The CPU executes the deceleration control. That is, the CPU controls the powertrain actuator 32 and the brake actuator 34 such that the acceleration G coincides with the target acceleration Gtgt.

Step 330: The CPU determines whether or not the collision target satisfying the collision condition is the movable particular target which is located outside the border BL and is movable.

The CPU specifies the position of the boundary BL with respect to the vehicle VA based on the boundary data, and determines whether or not the position of the collision target identified based on the camera object data and the radar object data is outside the boundary BL.

In addition, as one example, the CPU determines whether or not the collision object is the movable particular target based on the image data. Specifically, an image of a “movable particular target” is stored in advance as a template image in a storage device (not shown), and the CPU compares the image of the collision target with the template image to determine whether or not the collision target is the movable particular target.

As another example, the CPU determines whether or not the collision target is the movable particular target based on the reflected intensity of the reflected wave of the millimeter wave radar 24. This is because the reflection intensity varies for each type of target.

When the collision target is the movable particular target that is located outside the boundary BL and is movable, the CPU determines that the collision target satisfies the prohibition condition. In this case, the CPU makes a “Yes” determination in step 330 and proceeds to step 335. In step 335, the CPU sets a prohibition flag Xkns to “1”. Thereafter, the process proceeds to step 395, and the CPU terminates the present routine tentatively.

The prohibition flag Xkns is set to “1” when the execution of the deviation suppression control is prohibited, and is set to “0” when the execution of the deviation suppression control is permitted. The prohibition flag Xkns is set to “0” in an initialization routine. The initialization routine is executed by CPU when the ignition-key switch (not shown) of the vehicle VA is changed from an off-position to an on-position.

In a case where there is no target that may collide when the process proceeds to step 310, the CPU makes a “No” determination in step 310. The process proceeds to step 340. In step 340, the CPU sets the prohibition flag Xkns to “0”. Thereafter, the process proceeds to step 395, and the CPU terminates the present routine tentatively.

In a case where the minimum TTC is longer than the threshold time Tth when the process proceeds to step 320, the CPU makes a “No” determination in step 320. In this case, the process proceeds to step 340. In a case where the collision target does not satisfy the prohibition condition when the process proceeds to step 330, the CPU makes a “No” determination in step 330. In this case, the process proceeds to step 340.

### <Deviation Suppression Control Routine>

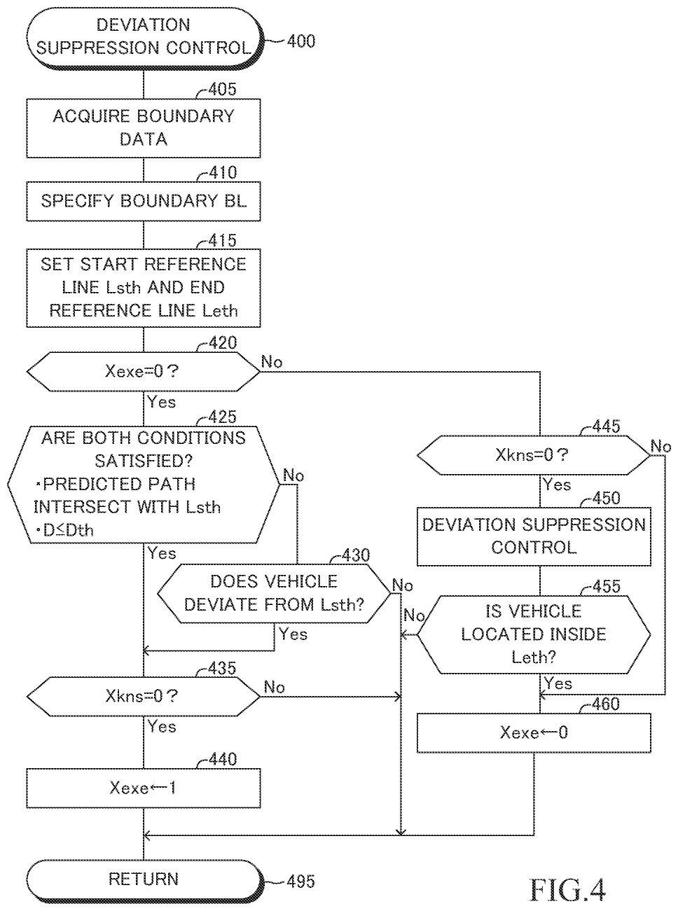

The CPU executes a deviation suppression control routine illustrated by a flowchart in FIG. 4 every time a predetermined period elapses.

When an appropriate time point comes, the CPU starts a process from step 400 of FIG. 4 and executes steps 405 to 420.

Step 405: The CPU acquires the boundary data from the camera 22.

Step 410: The CPU specifies the boundary BL based on the boundary data.

Step 415: The CPU sets the start reference line Lsth and the end reference line Leth.

Step 420: The CPU determines whether or not an execution flag Xexe is “0”.

The execution flag Xexe is set to “1” when the deviation suppression control starts, and is set to “0” when the deviation suppression control ends. The execution flag Xexe is set to “0” in the initialization routine.

When the execution flag Xexe is “0”, the CPU makes a “Yes” determination in step 420, and the process proceeds to step 425. In step 425, the CPU determines whether or not the condition (the above condition 1) that the predicted path PR intersects the start reference line Lsth and the distance D is equal to or shorter than the threshold distance Dth is satisfied.

When the condition (the above condition 1) is not satisfied, the CPU makes a “No” determination in step 425, and the process proceeds to step 430. In step 430, the CPU determines whether or not the vehicle VA deviates from the starting baseline Lsth.

When the vehicle VA does not deviate from the start reference line Lsth, the CPU makes a “No” determination in step 430, and the process proceeds to step 495. In step 495, the CPU terminates the present routine tentatively.

In a case where the condition (the above condition 1) is satisfied when the process proceeds to Step 425, the CPU makes a “Yes” determination in Step 425, and the process proceeds to Step 435. In step 435, the CPU determines whether or not the prohibition flag Xkns is “0”.

When the prohibition flag Xkns is “0”, the CPU makes a “Yes” determination in step 435, and the process proceeds to step 440. In step 440, the CPU sets the execution flag Xexe to “1”. Thereafter, the process proceeds to step 495, and the CPU terminates the present routine tentatively.

On the other hand, when the prohibition flag Xkns is “1”, the CPU makes a “No” determination in step 435, and the process proceeds to step 495. In step 495, the CPU terminates the present routine tentatively. In this case, although the deviation condition is satisfied, the value of the prohibition flag Xkns is set to “1” because the collision target satisfies the prohibition condition, and therefore the value of the execution flag Xexe is not set to “1”.

In a case where the vehicle VA deviates from the start reference line Lsth when the process proceeds to step 430, the CPU makes a “Yes” determination in step 430, the process proceeds to step 435.

In a case where the execution flag Xexe is “1” when the process proceeds to step 420, the CPU makes a “No” determination in step 420, and the process proceeds to step 445. In step 445, the CPU determines whether or not the prohibition flag Xkns is “0”.

When the prohibition flag Xkns is “0”, the CPU makes a “Yes” determination in step 445, and the process proceeds to step 450 and step 455.

Step 450: The CPU executes the deviation suppression control. That is, the CPU controls the steering motor 36 such that the steered angle θ coincides with the target steered angle θtgt.

Step 455: The CPU determines whether or not the vehicle VA is located inside the end reference line Leth.

When the vehicle VA is located outside the end reference line Leth, the CPU determines that the end condition is not satisfied. In step 455, the CPU makes a “No” determination, and the process proceeds to step 495. In step 495, the CPU terminates the present routine tentatively.

In a case where the prohibition flag Xkns is “1” when the process proceeds to step 445, the CPU makes a “No” determination in step 445, and the process proceeds to step 460. In step 460, the CPU sets the execution flag Xexe to “0”. Thereafter, the process proceeds to step 495, and the CPU terminates the present routine tentatively. In this case, since the collision target does not satisfy the prohibition condition when the deviation condition is satisfied, the deviation suppression control is started once, but since the collision target satisfies the prohibition condition thereafter, the deviation suppression control is stopped.

In a case where the vehicle VA is located inside the end reference line Leth when the process proceeds to step 455, the CPU determines that the end condition is satisfied. In this case, the CPU makes a “Yes” determination in step 455 and sets the execution flag Xexe to “0” in step 460. Thereafter, the process proceeds to step 495, and the CPU terminates the present routine tentatively.

As described above, when the collision target satisfies the prohibition condition, the execution of the deviation suppression control is prohibited, and when the collision target does not satisfy the prohibition condition, the execution of the deviation suppression control is permitted. Accordingly, it is possible to appropriately select whether the deviation suppression control and the deceleration control are executed at the same time or only the deceleration control is executed according to the collision target, and it is possible to reduce the possibility that the collision possibility increases by executing the deviation suppression control and to increase the possibility that the collision possibility decreases by executing the deviation suppression control.

The present disclosure is not limited to the above-described embodiment, and various modifications of the present disclosure can be adopted. In the above-described embodiment, the ECU20 may determine that the prohibition condition is satisfied when the collision target is the movable particular target, regardless of whether the collision target is located outside the border BL. As a result, it is possible to appropriately select whether the deviation suppression control and the deceleration control are executed at the same time or only the deceleration control is executed in accordance with the collision target.

Like the above-described embodiment, the prohibition condition is satisfied when the collision target is located outside the boundary BL and the collision target is the movable target. In this case, there is a higher possibility that the collision target moves in the same direction (inside the traveling area TR) as the steered direction by the deviation suppression control in order to avoid collision with the vehicle VA. Therefore, it is possible to reduce the possibility of erroneously prohibiting the execution of the deviation suppression control.

The ECU20 may determine that the prohibition condition is satisfied when the collision target is a target that is located outside the start reference line Lsth and the collision target is the movable target.

In the above embodiment, the ECU20 executes the deceleration control as the first control for reducing the collision possibility when the collision condition is satisfied, but the present disclosure is not limited thereto. As an example, the ECU20 may execute a warning control as the first control in order to reduce the collision possibility when the collision condition is satisfied. The warning control is a control for notifying the driver that there is a high possibility of collision with the collision target. For example, the ECU20 may display a warning screen for notifying the driver that that there is the high possibility of collision with the collision target on a display mounted on the vehicle VA. The ECU 20 cause a speaker mounted on the vehicle VA to output a predetermined warning sound.

Further, the ECU20 may execute the deceleration control and the warning control as the first control.

In the above embodiment, the ECU20 uses the TTC as a “collision index value representing the collision possibility”, but the ECU 20 may use the distance between the vehicle VA and the target as the collision index value.

The camera 22 may be a stereo camera or a monocular camera. The millimeter wave radar 24 may be a remote sensing device capable of detecting an object by transmitting a wireless medium other than millimeter waves and receiving a reflected wireless medium. Further, the present apparatus 10 may not include the millimeter-wave radar 24 as long as the position of the object with respect to the vehicle VA can be accurately identified based on the camera target data.

The apparatus 10 may be applied to a vehicle such as an engine vehicle, a Hybrid Electric Vehicle (HEV), a Plug-in Hybrid Electric Vehicle (PHEV), a Fuel Cell Electric Vehicle (FCEV), or a Battery Electric Vehicle (BEV). Furthermore, the apparatus 10 may also be applied to an autonomous driving control vehicle. Furthermore, the present disclosure can be regarded as a non-transitory storage medium in which a program for realizing the functions of the apparatus 10 is stored and which is readable by a computer.

What is claimed is:

1. A vehicle control apparatus configured to be capable of executing a first control for reducing a collision possibility between a vehicle and a target when the collision possibility satisfies a predetermined collision condition, and a second control for controlling a steered angle of the vehicle so as to suppress the vehicle from deviating from a traveling area defined by a boundary,
wherein,
the vehicle control apparatus configured to:
determine whether or not a collision target that satisfies the collision condition satisfies a predetermined prohibition condition;
prohibit an execution of the second control when the collision target satisfies the prohibition condition; and
permit the execution of the second control when the collision target does not satisfy the prohibition condition.

2. The vehicle control apparatus according to claim 1,
wherein the vehicle control apparatus configured to determine that the collision target satisfies the prohibition condition when the collision target is a movable particular target.

3. The vehicle control apparatus according to claim 2,
wherein the vehicle control apparatus configured to set a pedestrian and a two-wheeled vehicle as the movable particular target in advance.

4. The vehicle control apparatus according to claim 2,
wherein the vehicle control apparatus configured to determine that the collision target satisfies the prohibition condition when the collision target is the movable particular target and the collision target is located outside the boundary.

5. A non-transitory computer-readable storage medium storing a program for causing a processor to execute processing comprising:
executing a first control for reducing a collision possibility between a vehicle and a target when the collision possibility satisfies a predetermined collision condition, and a second control for controlling a steered angle of the vehicle so as to suppress the vehicle from deviating from a traveling area defined by a boundary;
determining whether or not a collision target that satisfies the collision condition satisfies a predetermined prohibition condition;
prohibiting an execution of the second control when the collision target satisfies the prohibition condition; and
permitting the execution of the second control when the collision target does not satisfy the prohibition condition.
